(19) United States
(12) Patent Application Publication
(10) Pub. No.: US 2013/0029219 A1
(43) Pub. Date: Jan. 31, 2013

(54) NONAQUEOUS ELECTROLYTE BATTERY

(71) Applicants: Hiroki INAGAKI, Kawasaki-shi (JP); Norio TAKAMI, Yokohama-shi (JP)

(72) Inventors: Hiroki INAGAKI, Kawasaki-shi (JP); Norio TAKAMI, Yokohama-shi (JP)

(21) Appl. No.: 13/646,144

(22) Filed: Oct. 5, 2012

Related U.S. Application Data
(63) Continuation of application No. PCT/JP2010/056252, filed on Apr. 6, 2010.

(51) Int. Cl. H01M 10/0564

(52) U.S. Cl. 429/200; 429/188

(57) ABSTRACT

According to one embodiment, a nonaqueous electrolyte battery includes a nonaqueous electrolyte which is a liquid at 20° C. under a pressure of 1 atmosphere. The nonaqueous electrolyte contains a first compound having a functional group represented by Chemical formula (I), at least one compound selected from a compound having an isocyanato group and a compound having an amino group, a nonaqueous solvent, and an electrolyte.

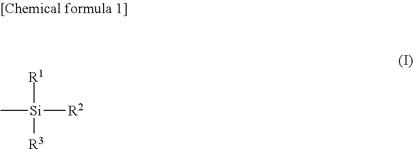

### CROSS REFERENCE TO RELATED APPLICATIONS

This application is a Continuation Application of PCT Application No. PCT/JP2010/056252, filed Apr. 6, 2010, the entire contents of which are incorporated herein by reference.

### FIELD

Embodiments described herein relate generally to a nonaqueous electrolyte battery.

### BACKGROUND

Recently, a nonaqueous electrolyte battery using an active material which causes insertion and release of lithium ion in a potential higher than that of a carbonaceous material, such as a lithium titanium composite oxide (about 1.56 V (vs Li/Li⁺⁾), as a negative electrode has been developed (see JP No. 3866740 and JP-A No. 9-199179). The lithium titanium composite oxide is excellent in cycle performance because the volume change accompanied by charge and discharge is low. Further, in the lithium titanium composite oxide, the deposition of lithium metal during the insertion/release reaction of lithium ion rarely occurs in principle. Thus, a battery using the lithium titanium composite oxide has little deterioration in performance even if the charge and discharge are repeated at a large current value.

### BRIEF DESCRIPTION OF THE DRAWINGS

FIG. 1 is a cross-sectional view of a flat type nonaqueous electrolyte secondary battery according to an embodiment;

FIG. 2 is an enlarged sectional view of a portion A in FIG. 1;

FIG. 3 is a partially cut perspective view of a nonaqueous electrolyte secondary battery according to another embodiment;

FIG. 4 is a cross-sectional view of a portion B in FIG. 3;

FIG. 5 is an exploded perspective view of a battery pack; and

FIG. 6 is a block diagram showing an electric circuit of the battery pack of FIG. 5.

### DETAILED DESCRIPTION

In general, according to one embodiment, a nonaqueous electrolyte battery includes a positive electrode; a negative electrode; and a nonaqueous electrolyte which is a liquid at 20° C. under a pressure of 1 atmosphere. The negative electrode contains a negative electrode active material causing insertion and release of lithium ion in a potential of 1.0 V or higher relative to metallic lithium. The nonaqueous electrolyte contains a first compound having a functional group represented by Chemical formula (I), at least one compound selected from a compound having an isocyanato group and a compound having an amino group, a nonaqueous solvent, and an electrolyte.

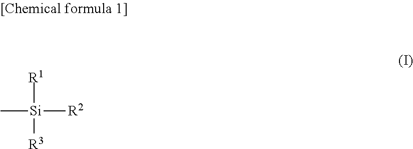

Here, R¹, R², and R³ each represent any one selected from the group consisting of an alkyl group having 1 to 10 carbon atoms, an alkenyl group having 2 to 10 carbon atoms, and an aryl group having 6 to 10 carbon atoms.

The self-discharge of the nonaqueous electrolyte battery using a material causing insertion and release of lithium ion at a high potential, such as a lithium titanium composite oxide, as a negative electrode active material is increased as compared with the nonaqueous electrolyte battery using a carbonaceous material. It is considered that the self-discharge is increased because a stable coating is difficult to be formed on such a material and thus, a decomposition reaction of a nonaqueous electrolyte is continuously generated. Further, in such a case, it is considered that a stable coating is difficult to be formed not only on a negative electrode active material but also on a negative electrode conductive agent and thus the influence becomes larger as the specific surface area of these material is increased.

If water is included in a battery, the water reacts with lithium salts such as LiBF₄ or LiPF₆ contained in the nonaqueous electrolyte to generate fluoric acid. The fluoric acid dissolves a constituting member of the battery, resulting in deterioration of battery performance. Particularly, when a transition metal element is contained in the active material of a positive electrode, fluoric acid dissolves the transition metal element. The dissolved transition metal element is precipitated on the surface of the negative electrode, resulting in an increase in battery resistance.

Generally, the nonaqueous electrolyte battery includes water derived from the constituting member or contaminated unavoidably in a manufacturing process. Since a —OH group is easily attached to the lithium titanium composite oxide, a battery using the lithium titanium composite oxide particularly has a tendency to include water. Thus, the battery resistance is significantly increased.

As the specific surface area of the lithium titanium composite oxide becomes larger, the amount of the adsorbed water is increased. Thus, as the specific surface area becomes larger, the influence of water is also increased.

For removing the water included in the nonaqueous electrolyte battery, it is possible to add activated alumina or the like to the battery. The activated alumina can adsorb water physically. However, the water removal effect of the activated alumina is low and the water adsorbed onto the activated alumina is released again at high temperatures.

However, according to the embodiment, it is possible to significantly suppress the self-discharge and reduce the battery resistance in a battery using a material causing insertion and release of lithium ion in a high potential. The battery according to the embodiment contains a nonaqueous electrolyte which is a liquid at 20° C. under a pressure of 1 atmosphere. The nonaqueous electrolyte is added at least one compound selected from a compound having an isocyanato group and a compound having an amino group, and a first compound having a functional group represented by Chemical formula (I) below.

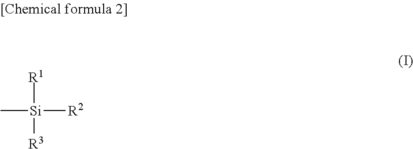

Here, R¹, R², and R³ each represent any one selected from the group consisting of an alkyl group having 1 to 10 carbon atoms, an alkenyl group having 2 to 10 carbon atoms, and an aryl group having 6 to 10 carbon atoms.

The compound having an isocyanato group (hereafter referred to “isocyanato compound”) immediately reacts with water as shown in Chemical formula (A) below.

—NCO+H₂O→—NH₂+CO₂ (A)

In the nonaqueous electrolyte, a part of the isocyanato compound is converted to the compound having an amino group (hereafter referred to “amino compound”) as shown in (A) at the time of the first charge. The amino compound produced by the reaction of Chemical formula (A) is stably present in the battery. A part of the amino compound dissolves into the nonaqueous electrolyte, and other part of the amino compound forms a thin and dense coating on the surface of the negative electrode. The coating generated from the amino compound is very stable, and thus it is possible to suppress the reaction of the negative electrode active material and the nonaqueous electrolyte.

The reduction potential of the isocyanato compound is about 0.9 V (vs Li/Li⁺). Herein, the term “V (vs Li/Li⁺)” is mean to a potential relative to metallic lithium. When the negative electrode'active material causing insertion and release of lithium ion in a potential higher than 1.0 V (vs Li/Li⁺) is used, the effect of the embodiment is obtained. On the other hand, when a carbonaceous material is used, the effect of the embodiment is not obtained. If the isocyanato compound is added to a battery using the carbonaceous material, the isocyanato compound is nearly completely decomposed to give a byproduct at the time of the first charge. The byproduct excessively contaminates the surface of the negative electrode. Thus, the battery performance such as charge and discharge performance or large current performance is significantly reduced.

Even when the isocyanato compound is added to the battery using the negative electrode active material causing insertion and release of lithium ion in a potential higher than 1.0 V (vs Li/Li⁺), the battery resistance may be slightly increased. The increase in resistance becomes a large problem when high input/output performance is required, for example, for automobile use.

However, it is possible to reduce the battery resistance by adding the first compound having a functional group represented by Chemical formula (I) together with the isocyanato compound. The first compound reacts with water to produce a decomposition product as shown in Chemical formula (B) below.

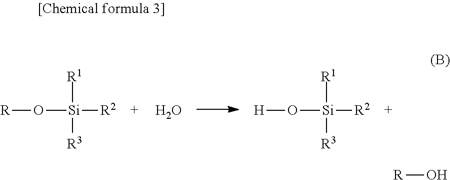

Further, the first compound reacts with fluoric acid to produce a decomposition product as shown in Chemical formula (C) below.

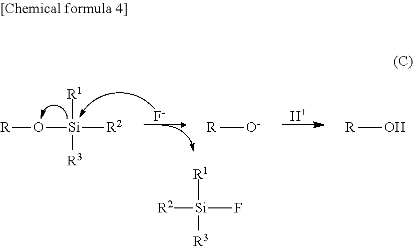

The first compound immediately reacts with water as shown in Chemical formula (B). Thus, it is expected that the compound has an effect of removing water in the nonaqueous electrolyte. Furtherer, it is expected that the compound has an effect by trapping fluoric acid as shown in Chemical formula (C). These effects contribute to an excellent cycle performance. The mechanism by which the battery resistance is reduced when the first compound is added is not made clear as yet, but it is considered that when the first compound or the decomposition products as shown in Chemical formula (B) and (C) are present in the coating formed from the amino compound, the resistance of coating decreases and stability of coating increases. Thus, the battery resistance can be lowered by adding the first compound together with the isocyanato compound as compared with a battery formed by adding the isocyanato compound alone. If the first compound is added alone, the battery resistance is lower than one of the battery formed without adding the isocyanato compound.

When the first compound and the isocyanato compound are added to the nonaqueous electrolyte according to the embodiment, the water in the nonaqueous electrolyte is removed and a stable coating is formed on the negative electrode but an excessive coating is not formed. Once the stable coating is formed on the negative electrode, the self-discharge caused by the reaction of the negative electrode with the nonaqueous electrolyte can be suppressed. Further, the coating has low resistance, and thus, the battery exhibits excellent large current performance. Moreover, since the excessive coating is not formed, high input/output performance is maintained.

The amino compound may be added together with the isocyanato compound or the amino compound may be added in place of the isocyanato compound. When the amino compound is added in place of the isocyanato compound, though an effect of removing water is not obtained, an effect of suppressing the self-discharge is obtained because a stable coating is formed.

The decomposition product of the first compound in the nonaqueous electrolyte can be detected by gas chromatography mass spectrometry (GC/MS). The isocyanato compound and the amino compound on the surface of the negative electrode can be detected by a Fourier transform infrared spectrophotometer (FT-IR).

The electrolyte solution to be detected is extracted by adjusting the battery to a half-charged state (SOC50%) and disassembling it in an inert atmosphere for examples, in an argon box. The negative electrode is taken from the disassembled battery. It is preferable that the negative electrode is taken from the center portion of an electrode group.

GC/MS analysis can be performed using GC/MS device 5989B (manufactured by Agilent) by the following method. As the measurement column, a DB-5MS (30 m×0.25 mm×0.25 μm) can be used. The electrolyte solution can be directly subjected to analysis or can be diluted with acetone, DMSO or the like.

FT-IR can be analyzed using Fourier transform infrared (FTIR) analyzer: FTS-60A (manufactured by BioRad Digilab) by the following method. The measurement conditions are as follows: light source: special ceramics, detector: DTGS, wave-number resolution: 4 cm⁻¹, cumulated number: 256, reference: gold deposition film. As an attachment device, a diffuse reflection measurement device (manufactured by PIKE Technologies) can be employed.

Even when the positive electrode active material does not contain the transition metal element, an effect of suppressing the gas caused by the reaction of the negative electrode with the nonaqueous electrolyte and an effect of forming a stable coating on the surface of the negative electrode are obtained. As a result, discharging performance at the large current are improved and the self-discharge is suppressed.

Hereinafter, the embodiment will be described with reference to the drawings. The same reference numerals denote common portions throughout the embodiments and an overlapped description is not repeated. Each drawing is a pattern diagram to facilitate the description of the embodiment and its understanding. The shape, size, and ratio thereof are different from those of an actual device. However, they can be appropriately designed and modified by taking into consideration the following description and known techniques.

### First Embodiment

A nonaqueous electrolyte battery according to the first embodiment is preferably a nonaqueous electrolyte secondary battery.

The nonaqueous electrolyte battery comprises a positive electrode, a negative electrode, a nonaqueous electrolyte, a separator, a positive electrode terminal, a negative electrode terminal, and a container.

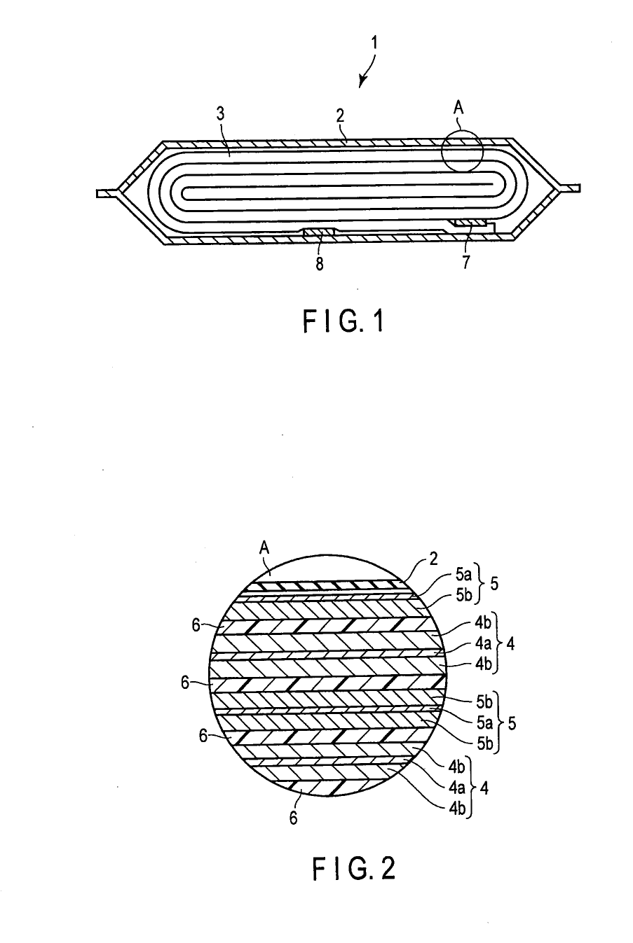

A flat type nonaqueous electrolyte battery is shown in FIG. 1 as an example of the nonaqueous electrolyte battery. FIG. 1 is a cross-sectional view of a flat type nonaqueous electrolyte battery. FIG. 2 is an enlarged sectional view of a portion A in FIG. 1.

A battery 1 comprises a container 2, a wound electrode group 3 with a flat shape, a positive electrode terminal 7, a negative electrode terminal 8, and a nonaqueous electrolyte.

The container 2 has baggy shape. The container 2 is made of a laminate film. The wound electrode group 3 is accommodated in the container 2.

The wound electrode group 3 comprises a positive electrode 4, a negative electrode 5, and a separator 6 as shown in FIG. 2.

The wound electrode group 3 is formed by spirally winding a laminated product obtained by laminating the negative electrode 5, the separator 6, the positive electrode 4, and the separator 6 in this order from the outside. The laminate is spirally wound so that the negative electrode is located at an outermost periphery. The wound laminate is pressed while heating, thus the flat-type electrode group 3 can be obtained.

The positive electrode 4 comprises a positive electrode current collector 4a and a positive electrode active material layer (hereinafter, referred to “the positive electrode layer”) 4b. The positive electrode layer 4b contains the positive electrode active material and optionally contains the conductive agent and the binder. The positive electrode layer 4b is formed on both surfaces of the positive electrode current collector 4a.

The negative electrode 5 comprises a negative electrode current collector 5a and a negative electrode active material layer (hereinafter, referred to “the negative electrode layer”) 5b. The negative electrode layer 5b contains the negative electrode active material and optionally contains the conductive agent and the binder.

In the outermost negative electrode 5, the negative electrode layer 5b is formed on the only inner surface of the negative electrode current collector 5a. In other portions, the negative electrode layer 5b is formed on both surfaces of the negative electrode current collector 5a.

As shown in FIG. 2, near the peripheral edge of the wound electrode group 3, the band-shaped positive electrode terminal 7 is connected to the positive electrode current collector 4a. The band-shaped negative electrode terminal 8 is connected to the negative electrode current collector 5a at the outermost layer of the wound electrode group. The positive electrode terminal 7 and the negative electrode terminal 8 are extended to outside through an opening of the container 2. The nonaqueous electrolyte is injected from the opening of the container 2. The wound electrode group 3 and the nonaqueous electrolyte can be completely sealed by heat-sealing the opening of the container 2 across the negative electrode terminal 8 and the positive electrode terminal 7.

The nonaqueous electrolyte contains a nonaqueous solvent, an electrolyte, the first compound, and at least one of the isocyanato and amino compounds.

As the negative electrode active material, an active material causing insertion and release of lithium ion in a potential of 1.0 V (vs Li/Li⁺) or higher is used.

When a material which causes insertion and release of lithium ion in a potential lower than the potential in which isocyanato and amino compounds are decomposed (e.g. 1.0 V (vs Li/Li⁺)), such as a carbonaceous material, is used as the negative electrode active material, the isocyanato compound or amino compound is excessively decomposed. Thus, a coating film is formed excessively on the surface of the negative electrode, resulting in high resistance. Therefore, the battery performance deteriorates significantly. Further, a large amount of gas is generated by an over-decomposition reaction of these compounds in themselves, resulting in deformation of the battery.

In order to make the battery voltage higher, it is preferable that the negative electrode active material causing insertion and release of lithium ion in a potential lower than 3 V (vs Li/Li⁺) is used.

The negative electrode active material preferably contains a lithium titanium composite oxide. Since the lithium titanium composite oxide causing insertion of lithium ion in the vicinity of 1.56 V (vs Li/Li⁺), the isocyanato compound which is added to the nonaqueous electrolyte is not decomposed excessively. Further, the decomposition of the amino compound is also suppressed.

Examples of the lithium titanium composite oxide include lithium titanium oxides such as Li₄₊ₓTi₅O₁₂ (0≦x≦3) and Li_{2+y}Ti₃O₇ (0≦y≦3) and a lithium titanium composite oxide obtained by substituting a part of the lithium titanium oxide by a heterologous element.

Examples of the negative electrode active material further include lithium niobium composite oxides causing insertion and release of lithium ion in a potential of 1 to 2 V (vs Li/Li⁺), such as LiₓNb₂O₅ (0≦x≦2) and LiₓNbO₃ (0≦x≦1); a lithium molybdenum composite oxide causing insertion and release of lithium ion in a potential of 2 to 3 V (vs Li/Li⁺), such as LiₓMoO₃ (0≦x≦1); and a lithium iron composite sulfide causing insertion and release of lithium ion in a potential of 1.8 V (vs Li/Li⁺), such as LiₓFeS₂ (0≦x≦4).

As the negative electrode active material, titanium oxide such as TiO₂ or a metal composite oxide containing at least one element selected from the group consisting of Ti, P, V, Sn, Cu, Ni, Co, and Fe also can be used. In the first charge of battery, lithium ion inserts these oxides thereby these oxides become a lithium titanium composite oxide. TiO₂ is preferably monoclinic system β-type (also referred to as bronze type or TiO₂ (B)) or anatase-type TiO₂ having low crystallinity. TiO₂ having low crystallinity can be obtained by a heat-treating at a temperature of 300 to 500° C. during the process of synthesis.

Examples of the metal composite oxide containing at least one element selected from the group consisting of Ti, P, V, Sn, Cu, Ni, Co, and Fe include TiO₂—P₂O₅, TiP₂—V₂O₅, TiO₂—P₂O₅—SnO₂ and TiO₂—P₂O₅-MeO (Me is at least one element selected from the group consisting of Cu, Ni, Co, and Fe). The metal composite oxide preferably has a microstructure in which a crystal phase and an amorphous phase coexist or the amorphous phase exists alone. Such a microstructure allows the cycle performance to be significantly improved.

These materials can be used as the negative electrode active material singly or in combinations of two or more.

The average primary particle diameter of the negative electrode active material is preferably 0.001 μm or more. When the average primary particle diameter is 0.001 μm or more, the bias of distribution of the nonaqueous electrolyte can be reduced. Thus, the partial depletion of the nonaqueous electrolyte in the positive electrode can be suppressed.

The average primary particle diameter of the negative electrode active material is preferably 1 μm or less. The specific surface area measured by the BET adsorption method with N₂ adsorption is preferably from 5 to 50 m²/g. When the average primary particle diameter and the specific surface area is in the above range, the impregnation of the nonaqueous electrolyte can be improved. The lithium titanium composite oxide has a high affinity for water. Thus, as the specific surface area is larger, an amount of water introduced into the cell is larger. Therefore, when the specific surface area of the negative electrode active material is large, the remarkable effect of the embodiment is obtained.

The porosity of the negative electrode layer is preferably in a range of 20 to 50%. Thus, a negative electrode having an excellent affinity for the nonaqueous electrolyte and having a high-density can be obtained. The porosity of the negative electrode layer is more preferably from 25 to 40%.

The density of the negative electrode layer is preferably 1.8 g/cc or more so that the porosity becomes in the above range. The density is more preferably from 1.8 to 2.5 g/cc.

The negative electrode current collector is preferably aluminum foil or aluminum alloy foil. The average crystal grain size of the negative electrode current collector is preferably 50 μm or less. Thus, the strength of the current collector can be dramatically increased. Therefore, the negative electrode can be pressed by high pressure, thereby the density of the negative electrode layer can be increased. As a result, the capacity of the battery can be increased. Also, an increase in negative electrode impedance can be suppressed since the deterioration due to dissolution and/or corrosive of the negative electrode current collector in the over-discharge state and under the hot environment (for example, at 40° C. or more) can be prevented. Further, output performance, rapid charging performance, and cycle performance can be improved. The average crystal grain size is more preferably 30 μm or less, still more preferably 5 μm or less.

The average crystal grain size is calculated as follows. The surface of the current collector is observed with an optical microscope and the number n of crystal grains present in a region of 1 mm×1 mm is counted. An average crystal grain area S is calculated by the equation S=1×10⁶/n (μm²) using the number n. An average crystal grain diameter d (μm) is calculated from the obtained value of S by equation (D) below.

D=2(S/n)^{1/2} (D)

The average crystal grain size is influenced by many factors such as the composition of materials, impurities, processing conditions, heat treatment histories and annealing conditions. The aluminum foil or aluminum alloy foil having an average crystal grain size (diameter) of 50 μm or less is made by combining the above-described various factors during a production process.

The thickness of the aluminum foil and the aluminum alloy foil is preferably 20 μm or less, more preferably 15 μm or less. The purity of the aluminum foil is preferably 99% by mass or more. Preferable examples of the aluminum alloy include alloys containing elements, such as magnesium, zinc, or silicon. On the other hand, the content of transition metals such as iron, copper, nickel, or chromium is preferably 1% by mass or less.

The negative electrode layer may contain the conductive agent. Examples of the conductive agent include a carbon material, metal powder such as aluminum powder, and conductive ceramics such as TiO. Examples of the carbon material include acetylene black, carbon black, corks, carbon fiber, and graphite. Examples of the preferably conductive agent include corks heat-treated by the temperature of 800 to 2000° C. and having an average particle diameter of 10 μm or less, graphite, powder of TiO, and carbon fiber having an average diameter of 1 μm or less. The BET specific surface area, based on N₂ adsorption, of those carbon materials is preferably 10 m²/g or more.

The negative electrode layer may contain the binder. Examples of the binder include polytetrafluoroethylene (PTFE), polyvinylidene fluoride (PVdF), fluorine-based rubber, styrene butadiene rubber, and a core shell binder.

The compounding ratio of the negative electrode active material, the conductive agent and the binder is preferably from 70% by mass to 96% by mass, from 2% by mass to 28%, from 2% by mass to 28% by mass, respectively. When the amount of the negative electrode conductive agent is 2% by mass or more, the current collection performance of the negative electrode layer can be improved, thereby the high current characteristics of the nonaqueous electrolyte battery can be improved. When the amount of the binder is 2% by mass or more, the binding property of the negative electrode layer to the negative electrode current collector becomes sufficient and high cycle performance is obtained. On the other hand, from the viewpoint of performance of high capacity, each contents of the negative electrode conductive agent and the binder is preferably 28% by mass.

The negative electrode can be produced by, for example, the following method. First, a negative electrode active material, a conductive agent, and a binder are suspended in a solvent to prepare slurry. The slurry is applied to one or both surfaces of a negative electrode current collector, followed by drying to form a negative electrode layer. Thereafter, the resultant layer is pressed. Alternatively, a pellet is formed from the negative electrode active material, the conductive agent, and the binder. The pellet is used as the negative electrode layer.

The nonaqueous electrolyte to be used in the embodiment is a liquid at an ordinary temperature (20° C.) under a pressure of 1 atmosphere. The nonaqueous electrolyte is prepared by dissolving an electrolyte in a nonaqueous solvent. In the nonaqueous electrolyte in liquid form at an ordinary temperature, a coating is formed on the surface of the negative electrode with the amino compound as described above.

The electrolyte is preferably dissolved in the nonaqueous solvent at a concentration of 0.5 mol/L to 2.5 mol/L.

To the nonaqueous electrolyte, a first compound having a functional group represented by Chemical formula (I), and an isocyanato compound and/or an amino compound are added. When these compounds are solids, they are dissolved in the nonaqueous solvent. When they are liquids, they are mixed with the nonaqueous solvent.

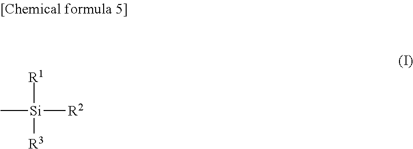

Here, R¹, R², and R³ each represent any one selected from the group consisting of an alkyl group having 1 to 10 carbon atoms, an alkenyl group having 2 to 10 carbon atoms, and an aryl group having 6 to 10 carbon atoms.

The first compound has one, two, or three functional groups represented by Chemical formula (I). The first compound is preferably a phosphoric or boric acid compound, particularly preferably a phosphoric acid compound. When the phosphoric or boric acid compound is added in the nonaqueous electrolyte, these compounds are reduced. Then, lithium phosphate and lithium borate are produced, respectively. These compounds are stabilized on the surface of the negative electrode so that they can contribute to the formation of a good coating.

The phosphoric acid compound is preferably silyl ester of phosphoric acid. For example, tris(trimethylsilyl)phosphate (TMSP) represented by Chemical formula (VI) below can be used.

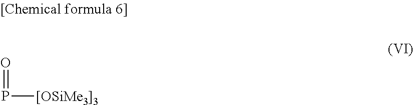

When tris(trimethylsilyl)phosphate is added to the nonaqueous electrolyte, it is decomposed to produce fluoro trimethylsilane ((CH₃)₃SiF). Therefore, fluorotrimethylsilane ((CH₃)₃SiF) can also be used as the first compound to be added.

When the boric acid compound such as tris(trimethylsilyl)borate is used, the compound is also decomposed to produce fluorotrimethylsilane ((CH₃)₃SiF).

Examples of the first compound having three functional groups represented by Chemical formula (I) above include tris(trimethylsilyl)phosphate, tris(triethylsilyl)phosphate, tris(vinyldimethylsilyl)phosphate, tris(trimethylsilyl)borate, and tris(triethylsilyl)borate. Particularly, tris(trimethylsilyl)phosphate is preferably used.

Examples of the first compound having two functional groups include bis(trimethylsilyl)methyl phosphate, bis(trimethylsilyl)ethylphosphate, bis(trimethylsilyl)-n-propylphosphate, bis(trimethylsilyl)-i-propylphosphate, bis(trimethylsilyl)-n-butylphosphate, bis(trimethylsilyl)trichloroethyl phosphate, bis(trimethylsilyl)trifluoroethyl phosphate, bis(trimethylsilyl)pentafluoropropyl phosphate, and bis(trimethylsilyl)phenyl phosphate.

Examples of the first compound having one functional group include dimethyltrimethylsilyl phosphate, diethyltrimethylsilyl phosphate, di-n-propyltrimethylsilyl phosphate, di-i-propyltrimethylsilyl phosphate, di-n-butyltrimethylsilyl phosphate, bis(trichloroethyl)trimethylsilyl phosphate, bis(trifluoroethyl)trimethylsilyl phosphate, bis(pentafluoro propyl)trimethylsilyl phosphate, and diphenyltrimethylsilyl phosphate.

As the first compound, the above compounds may be added alone or in combinations of two or more.

As the isocyanato compound, any compound having an isocyanato group may be used. The isocyanato compound may be a cyclic organic compound. However, a linear organic compound is desirable from the viewpoint of the influences on the environment. The isocyanato compound represented by Chemical formula (II) or (III) below is preferred because they have a higher dehydration effect.

R—NCO (II)

NCO—R—NCO (III)

In the formula, R represents a linear hydrocarbon having 1 to 10 carbon atoms.

As the molecular weight of the isocyanato compound is lower, a large effect can be obtained by a small additive amount. As the additive amount is smaller, there are few possibilities in changing properties of the nonaqueous electrolyte such as electric conductivity. Thus, R in Chemical formulae (II) and (III) is more preferably a linear hydrocarbon having 1 to 8 carbon atoms. It is more preferable that the isocyanato compound is a compound represented by Chemical formula (III). This is because when the compound has two isocyanato groups, the water removal effect is doubled. By using the compounds having higher water removal effects, water can be sufficiently removed even if the moisture content in the cell is increased.

Examples of the isocyanato compound include 1,2-diisocyanatoethane, 1,3-diisocyanatopropane, 1,4-diisocyanatobutane, 1,5-diisocyanatopentane, 1,6-diisocyanatohexane, 1,7-diisocyanatoheptane, 1,8-diisocyanatooctane, 1-isocyanatohexane, 1-isocyanatobutane, and ethylisocyanate. Most preferably, 1,6-diisocyanatohexane is used.

The isocyanato compound added to the nonaqueous electrolyte is converted into an amino compound by dehydration. Then, the amino compound forms a coating on the negative electrode. The isocyanato compound represented by Chemical formula (II) or (III) is converted into an amino compound represented by Chemical formula (IV) or (V) below, respectively.

R—NH₂ (IV)

NH₂—R—NH₂ (V)

In the formula, R represents a linear hydrocarbon having 1 to 10 carbon atoms.

The amino compound may be added to the nonaqueous electrolyte together with the isocyanato compound or in place of the isocyanato compound.

Examples of the amino compound include 1,2-diaminoethane, 1,3-diaminopropane, 1,4-diaminobutane, 1,5-diaminopentane, 1,6-diaminohexan, 1,7-diaminoheptane, 1,8-diaminooctane, 1-aminohexane, 1-aminobutane, and ethylamine.

In the nonaqueous electrolyte, the first compound slightly reacts in a potential higher than the potential at which the isocyanato compound decomposes. Thus, it is considered that the first compound has an effect of suppressing excessive decomposition of the isocyanato compound. Then, it is considered that the formation of the coating occurs preferentially to the decomposition reaction of the isocyanato compound. The coating has low charge transfer resistance. Thus, it enables lithium ions to be smoothly inserted in inner parts of the negative electrode and smoothly released therefrom. As a result, the initial resistance of battery can be reduced.

The content of the first compound is preferably 0.05% by mass or more based on the total mass of the nonaqueous electrolyte. When the content is 0.05% by mass or more, a resistance can be suppressed. As the content of the first compound is larger, the effect of suppressing resistance is increased. The content of the first compound is more preferably 0.1% by mass or more based on the total mass of the nonaqueous electrolyte. On the other hand, since the electric conductivity of the first compound is low, the high current performance of the battery may be reduced if an excessive amount of the compound is added. Therefore, the content of the first compound is preferably 5% by mass or less, more preferably 3% by mass or less based on the total mass of the nonaqueous electrolyte.

The content of the isocyanato compound is preferably adjusted to the range from 0.05% by mass to 2% by mass, more preferably from 0.1% by mass to 1% by mass based on the total mass of the nonaqueous electrolyte during preparation of the nonaqueous electrolyte. When the content is 0.05% by mass or more, the effect of suppressing the self-discharge is obtained over a long period of time. When the content is 2% by mass or less, the electric conductivity of the nonaqueous electrolyte is not reduced, and thus the high current performance of the battery can be maintained.

When the amino compound is added to the nonaqueous electrolyte together with the isocyanato compound or in place of the isocyanato compound, the total content of the amino compound and the isocyanato compound is preferably adjusted to the range from 0.05% by mass to 2% by mass based on the total mass of the nonaqueous electrolyte during preparation.

A part of the isocyanato compound reacts with water and converts to an amino compound. The amino compound forms a coating on the surface of the negative electrode in an initial charge of the battery. The total content of the isocyanato compound and amino compound before the initial charge is preferably from 0.05% by mass to 2% by mass based on the total mass of the nonaqueous electrolyte.

Examples of the electrolyte include lithium salts such as lithium perchlorate (LiClO₄), lithium hexafluorophosphate (LiPF₆), lithium tetrafluoroborate (LiBF₄), lithium hexafluoroarsenate (LiAsF₆), lithium trifluoromethasulfonate (LiCF₃SO₃), and lithium bis(trifluoromethylsulfonyl)imide [LiN(CF₃SO₂)₂]. The electrolytes which are hard to oxidize even at a high potential are preferably used. LiBF₄ or LiPF₆ is most preferably used. These electrolytes can be used alone or in combinations of two or more.

Examples of the nonaqueous solvent include cyclic carbonates such as propylene carbonate (PC), ethylene carbonate (EC), and vinylene carbonate; linear carbonates such as diethyl carbonate (DEC), dimethyl carbonate (DMC), and methylethyl carbonate (MEC); cyclic ethers such as tetrahydrofuran (THF), 2-methyltetrahydrofuran (2MeTHF), and dioxolane (DOX); linear ethers such as dimethoxyethane (DME) and diethoethane (DEE); and γ-butyrolactone (GBL), acetonitrile (AN), and sulfolane (SL). These solvents can be used alone or in combination.

A mixed solvent of two or more kinds selected form the group consisting of propylene carbonate (PC), ethylene carbonate (EC), and γ-butyrolactone (GBL) is preferably used. The reasons for this are as follows.

A first reason is that γ-butyrolactone, propylene carbonate, and ethylene carbonate have a high boiling point and flash point and are excellent in thermal stability.

A second reason is that the γ-butyrolactone is easily reduced as compared with linear or cyclic carbonates. Specifically, the property that is easily reduced is decreased in an order of γ-butyrolactone>>>ethylene carbonate>propylene carbonate>>dimethyl carbonate>methylethyl carbonate>diethyl carbonate. In the above, the more “>” marks are indicated, the more the difference between the property of solvent increases.

More preferably, a mixed solvent prepared by mixing γ-butyrolactone (GBL) with other solvents is used. The γ-butyrolactone is slightly reduced in the operating potential region of a lithium titanium composite oxide to give a decomposition product. The decomposition product, together with the amino compound, forms a more stable coating on the surface of the lithium titanium oxide. Thus, the above-described mixed solvent forms a more stable coating similarly. Therefore, a solvent which is easily reduced is used suitably.

In order to form a coating having superior property on the surface of the negative electrode, the content of the γ-butyrolactone is preferably from 40% by volume to 95% by volume based on the nonaqueous solvent.

Although the nonaqueous electrolyte containing γ-butyrolactone exhibits the excellent effect described above, the viscosity is high. Thus, it is difficult for the electrode to be impregnated with such a nonaqueous electrolyte. However, when a negative electrode active material having an average particle diameter of 1 μm or less is used, it is possible to perform impregnation of the nonaqueous electrolyte smoothly even if the nonaqueous electrolyte containing γ-butyrolactone is used. Therefore, it is possible to improve the productivity as well as to improve output performance and charge-discharge cycle performance.

As the positive electrode active material, an oxide, a sulfide, and a polymer can be used.

Examples of the oxide include lithium ion inserted manganese dioxide (MnO₂), iron oxide, copper oxide, and nickel oxide, and lithium manganese composite oxide (e.g. LiₓMn₂O₄ or LiₓMnO₂), lithium nickel composite oxide (e.g. LiₓNiO₂), lithium cobalt composite oxide (LiₓCoO₂), lithium nickel cobalt composite oxide (e.g. LiNi_{1-y}Co_{y}O₂), lithium manganese cobalt composite oxide (e.g. LiMn_{y}Co_{1-y}O₂), lithium manganese nickel composite oxide having spinel structure (e.g. LiₓMn_{2-y}Ni_{y}O₄), lithium phosphorus oxide having an olivine structure (e.g. LiₓFePO₄, LiₓFe_{1-y}Mn_{y}PO₄, LiₓCoPO₄ and the like), iron sulfate (e.g. Fe₂(SO₄)₃), vanadium oxide (e.g. V₂O₅), and lithium nickel cobalt manganese composite oxide. Here, x and y are preferably from 0 to 1.2.

Examples of the polymer include conductive polymer materials such as polyaniline or polypyrrole and disulfide based polymer materials.

Sulfur (S) or carbon fluoride can also be used as the positive electrode active material.

Examples of the positive electrode active material capable of providing a high positive electrode voltage include lithium manganese composite oxide (LiₓMn₂O₄), lithium nickel composite oxide (LiₓNiO₂), lithium cobalt composite oxide (LiₓCoO₂), lithium nickel cobalt composite oxide (LiₓNi_{1-y}Co_{y}O₂), lithium manganese nickel composite oxide having spinel structure (LiₓMn_{2-y}Ni_{y}O₄), lithium manganese cobalt composite oxide (LiₓMn_{y}Co_{1-y}O₂), lithium iron phosphate (LiₓFePO₄), and lithium nickel cobalt manganese composite oxide. Here, x and y are preferably from 0 to 1.2.

The composition of the lithium nickel cobalt manganese composite oxide is preferably LiₐNi_{b}Co_{c}Mn_{d}O₂. In the formula, a, b, c, and d satisfy a relationship represented by 0≦a≦1.2, 0.1≦b≦0.9, 0≦c≦0.9, and 0.1≦d≦0.5, respectively.

When a lithium transition metal composite oxide such as LiCoO₂ or LiMn₂O₄ is used as the positive electrode active material, the isocyanato compound is very slightly oxidized to produce a decomposition product. The decomposition product may cause contamination of the surface of the positive electrode. In this case, the surface of a particle of the lithium transition metal composite oxide is preferably coated, in part or entirely, with an oxide of at least one element of Al, Mg, Zr, B, Ti, or Ga. Thus, even when the isocyanato compound is contained in the nonaqueous electrolyte, the decomposition of the nonaqueous electrolyte on the surface of the positive electrode active material can be suppressed. Therefore, the contamination on the surface of the positive electrode can be reduced and a nonaqueous electrolyte battery having a longer life can be provided.

Examples of the oxide to be used for coating include Al₂O₃, MgO, ZrO₂, B₂O₃, TiO₂, and Ga₂O₃. The oxide content is preferably from 0.1% by mass to 15% by mass, more preferably 0.3% by mass to 5% by mass based on the amount of the lithium transition metal composite oxide. When the oxide content is 0.1% by mass or more, the decomposition of the nonaqueous electrolyte on the surface of the lithium transition metal composite oxide can be suppressed. When the oxide content is 15% by mass or less, the capacity of battery can be improved.

The positive electrode active material may contain the particles of the lithium transition metal composite oxide attached by the oxide described above as well as the particles of lithium transition metal composite oxide with no oxide.

As the oxide to be used for coating, MgO, ZrO₂ or B₂O₃ is preferably used. When the lithium transition metal composite oxide attached by such an oxide is used as the positive electrode active material, the charging potential can be further increased (for example, up to 4.4 V (vs Li/Li⁺) or more) and charge-discharge cycle performance can be improved.

The composition of the lithium transition metal composite oxide may contain other inevitable impurities.

The coating of the particles of lithium transition metal composite oxide can be performed as follows. First, the particles are impregnated with a solution containing an ion of an element M. The element M indicates at least one element selected from the group consisting of Al, Mg, Zr, B, Ti, and Ga. Then, the impregnated particles are sintered, thereby providing the particles of lithium transition metal composite oxide coated with an oxide of the element M.

Though, it is not particularly limited, the solution capable of attaching the oxide of the element M to the surface of the lithium transition metal composite oxide is used for impregnation. A solution containing at least one element selected from Al, Mg, Zr, B, Ti, or Ga can be used. These metal (boron is included) may be used, for example, in the form of an oxynitrate, a nitrate, acetate, sulfate, carbonate, hydroxide or acid.

The element M is preferably selected from Mg, Zr or B because the oxide to be used for coating is preferably MgO, ZrO₂ or B₂O₃ described above. Preferable examples of the ion solution containing the element M include an Mg(NO₃)₂ solution, a ZrO(NO₃)₂ solution, a ZrCO₄/ZrO₂/8H₂O solution, a Zr(SO₄)₂ solution and an H₃BO₃ solution. Among them, the Mg(NO₃)₂ solution, ZrO(NO₃)₂ solution or H₃BO₃ solution is most preferable.

The concentration of the element M in the ion solution is not particularly limited but a saturated solution is preferred. The use of the saturated solution allows the volume of the solution to be low in an impregnation process.

The form of the ion of the element M in the solution may be not only a single ion but also an ion bound to another element. For example, in the case of boron, it may be B(OH)₄⁻.

In the impregnation process, the mass ratio of the lithium transition metal composite oxide to the ion solution of the element M may be set according to the composition of the lithium transition metal composite oxide to be produced. The impregnation may be performed during the time that impregnation is substantially completed and the impregnation temperature is not particularly limited.

The sintering temperature and time can be appropriately determined. The sintering is preferably performed from 1 hour to 5 hours at the temperature from 400 to 800° C., more preferably performed about 3 hours at about 600° C. The sintering may be performed in the oxygen stream or air. The impregnated particles may be directly sintered. However, it is preferable to dry these particles before sintering in order to remove water in a mixture. The drying can be performed by a usually known method. For example, the heating in an oven and hot-air drying can be performed independently or in combination with each other. The drying is preferably performed in an atmosphere such as oxygen or air.

The coated lithium transition metal composite oxide thus obtained may be ground, if necessary.

The primary particle diameter of the positive electrode active material is preferably 100 nm or more and 1 μm or less. When it is 100 nm or more, the handling during the manufacture is made easy. When it is 1 μm or less, diffusion of lithium ions in a solid can smoothly proceed.

The specific surface area of the positive electrode active material is preferably from 0.1 m²/g to 10 m²/g. When it is 0.1 m²/g or more, sites for insertion and release of lithium ions are sufficiently ensured. When it is 10 m²/g or less, the handling during the manufacture is made easy, and a good charge-discharge cycle performance is obtained.

The conductive agent is used to improve the current collection performance and suppress the contact resistance with the current collector. Examples of the conductive agent include carbonaceous materials such as acetylene black, carbon black, or graphite.

The binder is used to fill gaps of the dispersed active material. Examples of the binder include polytetrafluoroethylene (PTFE), polyvinylidene fluoride (PVdF), and fluorine-based rubber.

In the active material layer, the content of the active material, the conductive agent, and the binder is preferably in the range from 80% by mass to 95% by mass, from 3% by mass to 18% by mass, and from 2% by mass to 17% by mass, respectively. When the content of the conductive agent is 3% by mass or more, the above effects can be exerted. When the content of the conductive agent is 18% by mass or less, decomposition of the nonaqueous electrolyte on the surface of the positive electrode conductive agent during storage under high temperature can be reduced. When the content of the binder is 2% by mass or more, sufficient electrode strength is obtained. When the content of the binder is 17% by mass or less, the blending amount of the insulator of the electrode can be decreased and the internal resistance can be reduced.

The positive electrode can be produced by the following method. First, a positive electrode active material, a conductive agent, and a binder are suspended in a solvent to prepare slurry. The slurry is applied to one or both surfaces of a positive electrode current collector, followed by drying to form a positive electrode layer. Thereafter, the resultant layer is pressed. Alternatively, a pellet is formed from the positive electrode active material, the conductive agent, and the binder. The pellet is used as the positive electrode layer.

The positive electrode current collector is preferably aluminum foil or an aluminum alloy foil. The average crystal grain size is preferably 50 μm or less. The diameter is more preferably 30 μm or less, still more preferably 5 μm or less. When the average crystal grain diameter is 50 μm or less, the strength of the current collector can be dramatically increased. Therefore, the positive electrode can be pressed by high pressure, thereby the density of the positive electrode layer can be increased. As a result, the capacity of the battery can be increased.

The average crystal grain size is influenced by many factors such as the composition of materials, impurities, processing conditions, heat treatment histories, and annealing conditions. The aluminum foil and aluminum alloy foil having an average crystal grain size (diameter) of 50 μm or less is made by combining the above-described various factors during a production process.

The thickness of the aluminum foil and the aluminum alloy foil is preferably 20 μm or less, more preferably 15 μm or less. The purity of the aluminum foil is preferably 99% by mass or more. Preferable examples of the aluminum alloy include alloys containing element, such as magnesium, zinc, or silicon. On the other hand, the content of transition metals such as iron, copper, nickel, or chromium is preferably 1% by mass or less.

As the separator, a porous film made from material such as polyethylene, polypropylene, cellulose, or polyvinylidene fluoride (PVdF), a synthetic resin nonwoven fabric or the like can be used. Since cellulose has a hydroxyl group at the end, water is easily introduced into the cell. Therefore, when a separator made from cellulose is used, the remarkable effect of the embodiment is obtained.

The separator preferably has a pore median diameter measured by a mercury intrusion technique from 0.15 μm to 2.0 μm. When the pore median diameter is 0.15 μm or more, the film resistance of the separator is reduced and high output is obtained. When the pore median diameter is 2.0 μm or less, the separator is uniformly shut down. Thus, high safety can be realized. Furthermore, diffusion of the nonaqueous electrolyte by capillarity is facilitated. As a result, deterioration of the performance due to the depletion of the nonaqueous electrolyte is prevented. The diameter is more preferably from 0.18 μm to 0.40 μm.

The separator preferably has a pore mode diameter measured by the mercury intrusion technique from 0.12 μm to 1.0 μm. When the pore mode diameter is 0.12 μm or more, the film resistance of the separator is low and high output is obtained. Furthermore, the deterioration of the separator in the state of high voltage under high temperature is prevented and thus high output is obtained. When the pore mode diameter is 1.0 μm or less, the separator is uniformly shut down. Thus, high safety can be realized. The diameter is more preferably from 0.18 μm to 0.35 μm.

The porosity of the separator is preferably from 45% to 75%. When the porosity is 45% or more, the absolute amount of ions in the separator is sufficient and high output is obtained. When the porosity is 75% or less, the strength of the separator is high and the separator is uniformly shut down. Thus, high safety can be realized. The porosity is more preferably from 50% to 65%.

As the container, a baggy container formed of a laminate film or a metal container is used.

Examples of the shape of the container include a flat type (thin type), angular type, cylinder type, coin type and button type sheet-type, lamination-type shapes. The container having a size corresponding to the dimensions of a battery are used. For example, containers for small-sized batteries to be mounted on portable electronic devices and containers for large-sized batteries to be mounted on, for example, two- to four-wheel vehicles are also used.

As the laminate film, a multilayer film prepared by interposing a metal layer between resin layers may be used. The metal layer is preferably formed of an aluminum foil or aluminum alloy foil to reduce the weight of the battery. For example, polymer materials such as polypropylene (PP), polyethylene (PE), nylon or polyethylene terephthalate (PET) may be used for the resin layer. The laminate film can be molded into a desired shape by sealing through thermal fusion. The thickness of the laminate film is preferably 0.5 mm or less, more preferably 0.2 mm or less.

The metal container may be made of aluminum, or an aluminum alloy. The aluminum alloy is preferably an alloy containing one or more elements selected from Mg, Zn, or Si. When the alloy contains transition metal such as Fe, Cu, Ni or Cr, the amount of the transition metal is preferably 1% by mass or less. When the amount of the transition metal is in the range, the long-term reliability under the high temperature and heat releasing property can be dramatically improved. The metal container preferably has a plate thickness of 1 mm or less, more preferably 0.5 mm or less.

The negative electrode terminal is made of, for example, a material having conductivity and electric stability in a potential range of 0.4 V to 3 V (vs Li/Li⁺). Specifically, examples of the materials include an aluminum alloy containing at least one element selected from Mg, Ti, Zn, Mn, Fe, Cu, or Si; and aluminum. The negative electrode terminal is preferably made of the same material as the negative electrode current collector to reduce the contact resistance with the negative electrode current collector.

The positive electrode terminal 7 is made of, for example, a material having conductivity and electric stability in a potential range of 3 V to 5 V (vs Li/Li⁺). Specific examples of the materials include an aluminum alloy containing at least one element selected from Mg, Ti, Zn, Mn, Fe, Cu or Si; and aluminum. The positive electrode terminal is preferably made of the same material as the positive electrode current collector to reduce the contact resistance with the positive electrode current collector.

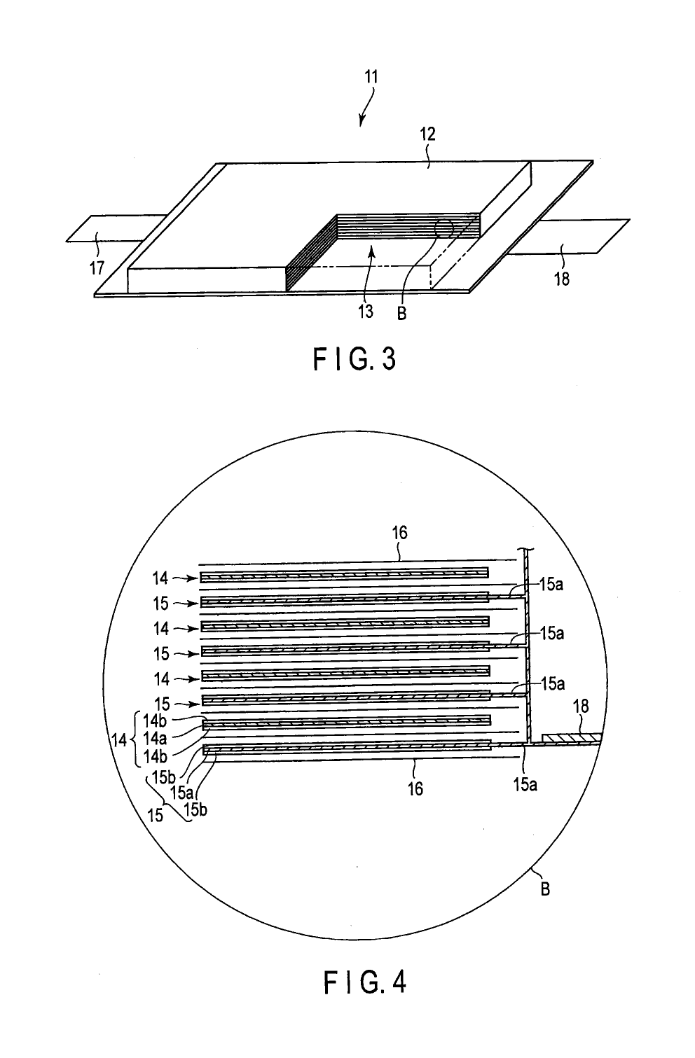

FIGS. 3 and 4 show the different type of nonaqueous electrolyte secondary battery. FIG. 3 is a partially cut perspective view of a flat-type nonaqueous electrolyte secondary battery 11. FIG. 4 is an enlarged view of a portion B of FIG. 3.

A battery 11 comprises a container 12, a lamination-type electrode group 13 accommodated in the container 12a positive electrode terminal 17, and a negative electrode terminal 18, and a nonaqueous electrolyte.

The container 12 is formed of a laminate film in which a metal layer is interposed between two resin films. As for the lamination-type electrode group 13, as shown in FIG. 4, a laminate is formed by inserting a separator 16 between the positive electrode 14 and the negative electrode 15 and alternately laminating them.

A plurality of the positive electrodes 14 are present and they comprise a positive electrode current collector 14a and a positive electrode layer 14b provided on each surface of the positive electrode current collector 14a. A plurality of the negative electrodes 15 are present and they comprise the negative electrode current collector 15a and a negative electrode layer 15b provided on each surface of the negative electrode current collector 15a.

One side of the each negative electrode current collectors 15a is protruded from the laminate and connected to the band-shaped negative electrode terminal 18. Similarly, not illustrated, one side of the each positive electrode current collectors 14a is protruded from the laminate at the opposite side which the negative electrode current collector 15a is protruded from the laminate. The positive electrode current collectors 14a are connected to the band-shaped positive electrode terminal 17.

The end of the negative electrode terminal 18 is externally drawn out of the container 12. The end of the positive electrode terminal 17 is positioned opposite to the negative electrode terminal 18 and externally drawn out the container 12.

Further, the nonaqueous electrolyte is injected into the container 12.

According to the embodiment, it is possible to suppress the self-discharge in the nonaqueous electrolyte battery and reduce battery resistance. Thus, the nonaqueous electrolyte battery having good input/output performance can be provided.

### Second Embodiment

Subsequently, a battery pack according to a second embodiment will be explained with reference to the drawings. The battery pack comprises one or more of the above nonaqueous electrolyte batteries (unit cells) according to the first embodiment. When the battery pack includes two or more unit cells, these unit cells are disposed in such a manner that they are electrically connected in series or in parallel.

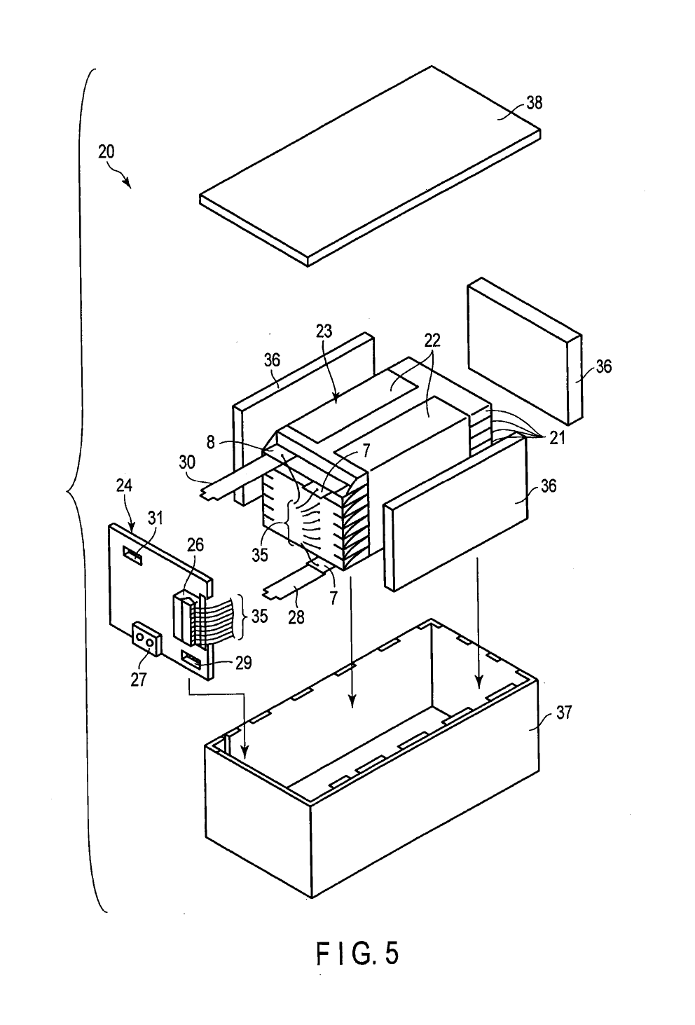

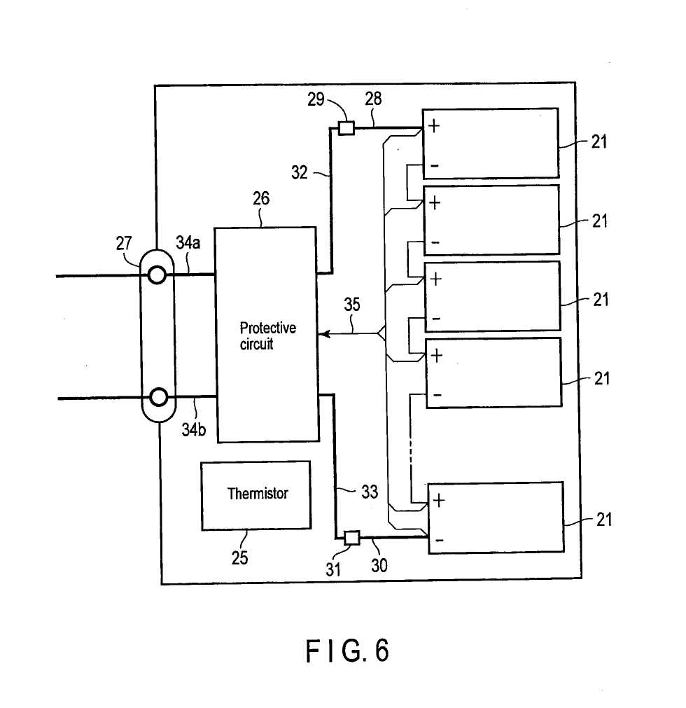

FIG. 5 and FIG. 6 show an example of a battery pack 20. This battery pack 20 comprises a plurality of flat-type unit cells 21 having the structure shown in FIG. 1. FIG. 5 is an exploded perspective view of the battery pack 20. FIG. 6 is a block pattern showing the electric circuit of the battery pack 20 shown in FIG. 5.

A plurality of unit cells 21 are laminated such that the externally extended positive electrode terminal 7 and negative electrode terminal 8 are arranged in the same direction and fastened with an adhesive tape 22 to thereby constitute a battery module 23. These unit cells 21 are electrically connected in series as shown in FIG. 6.

A printed wiring board 24 is disposed opposite to the side surface of the unit cell 21 from which the positive electrode terminal 7 and negative electrode terminal 8 are extended. As shown in FIG. 6, a thermistor 25, a protective circuit 26 and an energizing terminal 27 connected to external devices are mounted on the printed wiring board 24. An insulating plate (not shown) is attached to the surface of the printed wiring board 24 facing the battery module 23 to avoid unnecessary connection with the wiring of the battery module 23.

A positive electrode side lead 28 is connected to the positive electrode terminal 7 positioned on the lowermost layer of the battery module 23 and one end of the positive electrode side lead 28 is inserted into and electrically connected to a positive electrode side connector 29 of the printed wiring board 24. A negative electrode side lead 30 is connected to the negative electrode terminal 8 positioned on the uppermost layer of the battery module 23 and one end of the negative electrode side lead 30 is inserted into and electrically connected to a negative electrode side connector 31 of the printed wiring board 24. These connectors 29 and 31 are connected to the protective circuit 26 through wirings 32 and 33 formed on the printed wiring board 24.

The thermistor 25 is used to detect the temperature of the unit cell 21 and the detected signals are transmitted to the protective circuit 26. The protective circuit 26 can shut off a plus side wiring 34a and minus side wiring 34b between the protective circuit 26 and the energizing terminal 27 connected to external devices in a predetermined condition. The predetermined condition means, for example, the case where the temperature detected by the thermistor 25 is a predetermined one or higher. Also, the predetermined condition means, for example, the case of detecting overcharge, overdischarge and over-current of the unit cell 21. The detections of this overcharge and the like are made for individual unit cells 21 or whole unit cells 21. When individual unit cells 21 are detected, either the voltage of the battery may be detected or the potential of the positive electrode or negative electrode may be detected. In the latter case, a lithium electrode used as a reference electrode is inserted between individual unit cells 21. In the case of FIG. 5 and FIG. 6, a wiring 35 for detecting voltage is connected to each unit cell 21 and the detected signals are transmitted to the protective circuit 26 through these wirings 35.

A protective sheet 36 made of a rubber or resin is disposed on each of the three side surfaces of the battery module 23 excluding the side surface from which the positive electrode terminal 7 and negative electrode terminal 8 are projected.

The battery module 23 is accommodated in a container 37 together with each protective sheet 36 and printed wiring board 24. Specifically, the protective sheet 36 is disposed on each inside surface in the direction of the long side and on one of the inside surfaces in the direction of the short side of the container 37, and the printed wiring board 24 is disposed on the other inside surface in the direction of the short side. The battery module 23 is positioned in a space enclosed by the protective sheet 36 and the printed wiring board 24. A lid 38 is attached to the upper surface of the container 37.

Here, a thermally contracting tape may be used in place of the adhesive tape 22 to secure the battery module 23. In this case, after the protective sheet is disposed on both sides of the battery module and the thermally contracting tubes are wound around the battery module; the thermally contracting tape is contracted by heating to fasten the battery module.

The structure in which the unit cells 21 are connected in series is shown in FIG. 5 and FIG. 6. However, these unit cells may be connected in parallel to increase the capacity of the battery. The assembled battery packs may be further connected in series or in parallel.

The form of the battery pack is appropriately changed according to the use. The battery pack according to this embodiment is suitably used for the application which requires excellent cycle characteristics when a high current is taken out. It is used specifically as a power source for digital cameras, for vehicles such as two- or four-wheel hybrid electric vehicles, for two- or four-wheel electric vehicles, and for assisted bicycles. Particularly, it is suitably used as a battery for automobile use.

Accordingly to the embodiment, the battery pack having good input/output performance can be provided.

### EXAMPLES

Hereinafter, examples will be described, however, the embodiment is not limited to the following examples.

### Example A-1)

### Production of Positive Electrode

As the positive electrode active material, 90% by mass of lithium nickel composite oxide (LiNi_{0.82}Co_{0.15}Al_{0.03}O₂) powder was used. As the conductive agent, 3% by mass of acetylene black and 3% by mass of graphite were used. As the binder, 4% by mass of polyvinylidene fluoride (PVdF) was used. These materials were added to N-methylpyrrolidone (NMP) and mixed to prepare a slurry. The slurry was applied to each surface of a current collector made of an aluminum foil having a thickness of 15 μm. Then, the slurry was dried and pressed to obtain a positive electrode having an electrode density of 3.15 g/cm³.

<Production of Negative Electrode>

As the negative electrode active material, lithium titanate (Li₄Ti₅O₁₂) powder having a spinel structure was prepared. The average particle diameter of the powder was 0.84 μm. BET specific surface area of the powder was 10.8 m²/g. The potential at which the lithium titanate caused insertion and release of lithium ion was 1.56 V (vs Li/Li⁺). The particle diameter of the negative electrode active material was measured using a laser diffraction type distribution measurement device (SALD-300; Shimadzu Corporation) in the following manner. First, about 0.1 g of a sample, a surfactant, and 1 to 2 mL of distilled water were put into a beaker and the mixture was sufficiently stirred. The mixture was poured into an agitation water bath and the luminous intensity distribution was measured 64 times at intervals of two seconds. The data for particle size distribution thus obtained was analyzed to determine the particle diameter.

90% by mass of the negative electrode active material, 7% by mass of graphite as the conductive agent, and 3% by mass of polyvinylidene fluoride (PVdF) as the binder were used. These materials and NMP were mixed so as to have a solid content ratio of 62%. While kneading the obtained mixture with a planetary mixer, NMP was added to the mixture so that the solid ratio was gradually reduced. Thus, a slurry having a viscosity of 10.2 cp (measured by Brookfield type viscometer at 50 rpm) was prepared. This slurry was mixed in a bead mill with zirconia balls having a diameter of 1 mm as media.

The obtained slurry was applied to each surface of a current collector made of an aluminum foil (purity: 99.3% by mass, average crystal grain size: 10 μm) having a thickness of 15 μm. Then, the slurry was dried and pressed using a roll heated to 100° C. to obtain a negative electrode.

<Production of an Electrode Group>

As the separator, a nonwoven fabric having thickness of 25 μm made of cellulose was used.

The positive electrode, the separator, the negative electrode, and the separator were stacked in this order to form a laminate. Then, the laminate was spirally wound. The resultant product was hot-pressed at 80° C. to produce a flat type electrode group having a height of 100 mm, a width of 70 mm, and a thickness of 4 mm. The obtained electrode group was accommodated in a pack made of a laminate film and vacuum-dried at 80° C. for 16 hours. The laminate film had a three-layered structure of nylon/aluminum/polyethylene and a thickness of 0.1 mm.

<Preparation of Liquid Nonaqueous Electrolyte>

1 mol/L of LiPF₆ was dissolved in a mixed solvent of propylene carbonate (PC) and diethyl carbonate (DEC) (volume ratio 1:2). 2% by mass of tris(trimethylsilyl)phosphate as the first compound and 0.5% by mass of 1,6-diisocyanatohexane as the isocyanato compound was added to the mixed solvent followed by mixing them to prepare a nonaqueous electrolyte. The proportion by mass described above is based on the total mass of the nonaqueous electrolyte.

The nonaqueous electrolyte was injected into a laminated film pack in which the electrode group was accommodated. Then, the pack was completely sealed by heat sealing. As a result, a nonaqueous electrolyte secondary battery having a structure as shown in FIG. 1, a height of 110 mm, a width of 72 mm, and a thickness of 4 mm was obtained.

The negative electrode active material, the positive electrode active material, the added first compound, the additive amount thereof, the added isocyanato compound and the additive amount thereof are shown in Table 1.

### Comparative Examples A-1 to A-3, Examples A-2 to A-7

Nonaqueous electrolyte secondary batteries were produced similarly to Example A-1 except that the additive amounts of tris(trimethylsilyl)phosphate and 1,6-diisocyanatohexane were changed as shown in Table 1 during preparation of the nonaqueous electrolyte.

### Comparative Examples B-1 and B-2, Examples B-1 to B-4

Nonaqueous electrolyte secondary batteries were produced similarly to Example A-1 except that the first compound and its additive amount and the isocyanato compound and its additive amount were changed as shown in Table 1 during preparation of the nonaqueous electrolyte.

### Comparative Example C and Example C

Nonaqueous electrolyte secondary batteries were produced similarly to Comparative example A-1 and Example A-1 except that monoclinic system TiO₂(B) was used as the negative electrode active material as shown in Table 2. The potential in which insertion and release of lithium ion occur in the monoclinic system TiO₂ (B) was from 1 to 2 V (vs Li/Li⁺).

### Comparative Examples D-1 and D-2

Nonaqueous electrolyte secondary batteries were produced similarly to Comparative example A-1 and Example A-1 except that graphite having an average particle diameter of 6 μm was used as the negative electrode active material as shown in Table 2. The potential in which insertion and release of lithium ion occur in the graphite was from 0 to 0.2 V (vs Li/Li⁺).

### Comparative Examples E-1 to E-3, Example E

Nonaqueous electrolyte secondary batteries were produced similarly to Comparative examples A-1 to A-3 and Example A-1 except that a lithium nickel cobalt manganese composite oxide (LiNi_{0.6}Co_{0.2}Mn_{0.2}O₂) was used as the positive electrode active material as shown in Table 2.

(Electrochemical Measurement)

The batteries according to the examples and comparative examples were stored in a 50% charged state (SOC50%) under the temperature of 60° C. during one month. Thereafter, the batteries were discharged and the remaining capacity was measured. The ratio of the capacity after storage to the capacity before storage was calculated to obtain the value of the remaining capacity ratio. The results are shown in Tables 3 and 4.

The alternating current resistance each of the batteries according to the examples and comparative examples before storage was measured in a 50% charged state (SOC50%), thus the value of the impedance (mΩ) at 1 kHz was obtained. The results are shown in Tables 3 and 4. The impedance is shown as a ratio calculated taking the impedance of the batteries according to Comparative examples A-1, C, D-1, and E-1 in which none of the additives were added as a 1.00.

(Component Detection)

For the batteries according to each of the examples and comparative examples before the test, the components contained in the battery were detected. Specifically, components I and II present in an electrolyte solution were detected by gas chromatography mass spectrometry (GC/MS). Here, the component I indicates a decomposition product of the first compound and the component II indicates an isocyanato compound.

The surface of the negative electrode was detected by the Fourier transform infrared spectrophotometer (FT-IR). In the FT-IR detection, the presence of amide, namely, the compound having an amino group is suggested from the peak appearing at about 1690 cm⁻¹, and the presence of the compound having an isocyanato group is suggested from the peak appearing at about 2275 cm⁻¹.

The compounds detected as components I and II and the peak positions detected by FT-IR are shown in both Tables 3 and 4.

TABLE 1

| | | | | Additive | | Additive |
|---|---|---|---|---|---|---|
| | Negative electrode | Positive electrode | | amount | | amount |
| | active material | active material | First compound | (% by mass) | Isocyanato compound | (% by mass) |
| Comparative | Li₄Ti₅O₁₂ | LiNi_{0.82}Co_{0.15}Al_{0.03}O₂ | — | — | — | — |
| Example A-1 | | | | | | |
| Comparative | Li₄Ti₅O₁₂ | LiNi_{0.82}Co_{0.15}Al_{0.03}O₂ | — | — | 1,6-Diisocyanatohexane | 0.5 |
| Example A-2 | | | | | | |
| Comparative | Li₄Ti₅O₁₂ | LiNi_{0.82}Co_{0.15}Al_{0.03}O₂ | Tris(trimethylsilyl)phosphate | 2 | — | — |
| Example A-3 | | | | | | |
| Example A-1 | Li₄Ti₅O₁₂ | LiNi_{0.82}Co_{0.15}Al_{0.03}O₂ | Tris(trimethylsilyl)phosphate | 2 | 1,6-Diisocyanatohexane | 0.5 |
| Example A-2 | Li₄Ti₅O₁₂ | LiNi_{0.82}Co_{0.15}Al_{0.03}O₂ | Tris(trimethylsilyl)phosphate | 0.05 | 1,6-Diisocyanatohexane | 0.05 |
| Example A-3 | Li₄Ti₅O₁₂ | LiNi_{0.82}Co_{0.15}Al_{0.03}O₂ | Tris(trimethylsilyl)phosphate | 0.5 | 1,6-Diisocyanatohexane | 0.05 |
| Example A-4 | Li₄Ti₅O₁₂ | LiNi_{0.82}Co_{0.15}Al_{0.03}O₂ | Tris(trimethylsilyl)phosphate | 2 | 1,6-Diisocyanatohexane | 0.1 |
| Example A-5 | Li₄Ti₅O₁₂ | LiNi_{0.82}Co_{0.15}Al_{0.03}O₂ | Tris(trimethylsilyl)phosphate | 2 | 1,6-Diisocyanatohexane | 1 |
| Example A-6 | Li₄Ti₅O₁₂ | LiNi_{0.82}Co_{0.15}Al_{0.03}O₂ | Tris(trimethylsilyl)phosphate | 2 | 1,6-Diisocyanatohexane | 2 |
| Example A-7 | Li₄Ti₅O₁₂ | LiNi_{0.82}Co_{0.15}Al_{0.03}O₂ | Tris(trimethylsilyl)phosphate | 5 | 1,6-Diisocyanatohexane | 1 |
| Comparative | Li₄Ti₅O₁₂ | LiNi_{0.82}Co_{0.15}Al_{0.03}O₂ | — | — | 1,4-Diisocyanatobutane | 0.5 |
| Example B-1 | | | | | | |
| Comparative | Li₄Ti₅O₁₂ | LiNi_{0.82}Co_{0.15}Al_{0.03}O₂ | Tris(trimethylsilyl)borate | 2 | — | — |
| Example B-2 | | | | | | |
| Example B-1 | Li₄Ti₅O₁₂ | LiNi_{0.82}Co_{0.15}Al_{0.03}O₂ | Tris(trimethylsilyl)borate | 2 | 1,4-Diisocyanatobutane | 0.5 |
| Example B-2 | Li₄Ti₅O₁₂ | LiNi_{0.82}Co_{0.15}Al_{0.03}O₂ | Tris(trimethylsilyl)phosphate | 2 | 1-Isocyanato hexane | 0.5 |
| Example B-3 | Li₄Ti₅O₁₂ | LiNi_{0.82}Co_{0.15}Al_{0.03}O₂ | Tris(trimethylsilyl)phosphate | 2 | 1-Isocyanato butane | 0.5 |
| Example B-4 | Li₄Ti₅O₁₂ | LiNi_{0.82}Co_{0.15}Al_{0.03}O₂ | Fluoro trimethylsilane | 0.5 | 1,6-Diisocyanatohexane | 0.5 |

TABLE 2

| | | | | Additive | | Additive |
|---|---|---|---|---|---|---|
| | Negative electrode | Positive electrode | | amount | | amount |
| | active material | active material | First compound | (% by mass) | Isocyanato compound | (% by mass) |
| Comparative | TiO₂(B) | LiNi_{0.82}Co_{0.15}Al_{0.03}O₂ | — | — | — | — |
| Example C | | | | | | |
| Example C | TiO₂(B) | LiNi_{0.82}Co_{0.15}Al_{0.03}O₂ | Tris(trimethylsilyl)phosphate | 2 | 1,6-Diisocyanatohexane | 0.5 |
| Comparative | Graphite | LiNi_{0.82}Co_{0.15}Al_{0.03}O₂ | — | — | — | — |
| Example D-1 | | | | | | |
| Comparative | Graphite | LiNi_{0.82}Co_{0.15}Al_{0.03}O₂ | Tris(trimethylsilyl)phosphate | 2 | 1,6-Diisocyanatohexane | 0.5 |
| Example D-2 | | | | | | |
| Comparative | Li₄Ti₅O₁₂ | LiNi_{0.6}Co_{0.2}Mn_{0.2}O₂ | — | — | — | — |
| Example E-1 | | | | | | |
| Comparative | Li₄Ti₅O₁₂ | LiNi_{0.6}Co_{0.2}Mn_{0.2}O₂ | — | — | 1,6-Diisocyanatohexane | 0.5 |
| Example E-2 | | | | | | |
| Comparative | Li₄Ti₅O₁₂ | LiNi_{0.6}Co_{0.2}Mn_{0.2}O₂ | Tris(trimethylsilyl)phosphate | 2 | — | — |
| Example E-3 | | | | | | |
| Example E | Li₄Ti₅O₁₂ | LiNi_{0.6}Co_{0.2}Mn_{0.2}O₂ | Tris(trimethylsilyl)phosphate | 2 | 1,6-Diisocyanatohexane | 0.5 |

TABLE 3

| | | | | Remaining | |
|---|---|---|---|---|---|
| | Detection | Detection | Peak position | capacity | Impedance |
| | component I | component II | of FT-IR | ratio (%) | at 1 kHz |
| Comparative | — | — | — | 36 | 1.00 |
| Example A-1 | | | | | |
| Comparative | — | — | About 1690 cm⁻¹ | 51 | 1.04 |
| Example A-2 | | | | | |
| Comparative | Fluoro trimethylsilane | — | — | 34 | 0.98 |
| Example A-3 | | | | | |
| Example A-1 | Fluoro trimethylsilane | — | About 1690 cm⁻¹ | 53 | 0.93 |
| Example A-2 | Fluoro trimethylsilane | — | About 1690 cm⁻¹ | 44 | 0.93 |
| Example A-3 | Fluoro trimethylsilane | — | About 1690 cm⁻¹ | 45 | 0.90 |
| Example A-4 | Fluoro trimethylsilane | — | About 1690 cm⁻¹ | 48 | 0.90 |
| Example A-5 | Fluoro trimethylsilane | 1,6-Diisocyanatohexane | About 1690 cm⁻¹, | 62 | 0.94 |
| | | | About 2275 cm⁻¹ | | |
| Example A-6 | Fluoro trimethylsilane | 1,6-Diisocyanatohexane | About 1690 cm⁻¹, | 64 | 0.96 |
| | | | About 2275 cm⁻¹ | | |
| Example A-7 | Fluoro trimethylsilane | — | About 1690 cm⁻¹ | 60 | 0.92 |
| Comparative | — | 1,4-Diisocyanatobutane | About 1690 cm⁻¹, | 53 | 1.05 |
| Example B-1 | | | About 2275 cm⁻¹ | | |
| Comparative | Fluoro trimethylsilane | — | — | 35 | 0.99 |
| Example B-2 | | | | | |
| Example B-1 | Fluoro trimethylsilane | 1,4-Diisocyanatobutane | About 1690 cm⁻¹, | 55 | 0.93 |
| | | | About 2275 cm⁻¹ | | |
| Example B-2 | Fluoro trimethylsilane | — | About 1690 cm⁻¹ | 52 | 0.92 |
| Example B-3 | Fluoro trimethylsilane | — | About 1690 cm⁻¹ | 50 | 0.92 |
| Example B-4 | Fluoro trimethylsilane | — | About 1690 cm⁻¹ | 53 | 0.94 |

TABLE 4

| | | | | Remaining | |
|---|---|---|---|---|---|
| | Detection | Detection | Peak position | capacity | Impedance |
| | component I | component II | of FT-IR | ratio (%) | at 1 kHz |
| Comparative | — | — | — | 22 | 1.00 |
| Example C | | | | | |
| Example C | Fluoro trimethylsilane | 1,6-Diisocyanatohexane | About 1690 cm⁻¹, | 55 | 0.94 |
| | | | About 2275 cm⁻¹ | | |
| Comparative | — | — | — | 60 | 1.00 |
| Example D-1 | | | | | |
| Comparative | Fluoro trimethylsilane | 1,6-Diisocyanatohexane | About 1690 cm⁻¹, | 30 | 1.35 |
| Example D-2 | | | About 2275 cm⁻¹ | | |
| Comparative | — | — | — | 38 | 1.00 |
| Example E-1 | | | | | |
| Comparative | — | 1,6-Diisocyanatohexane | About 1690 cm⁻¹, | 56 | 1.04 |
| Example E-2 | | | About 2275 cm⁻¹ | | |
| Comparative | Fluoro trimethylsilane | — | — | 37 | 0.98 |
| Example E-3 | | | | | |
| Example E | Fluoro trimethylsilane | 1,6-Diisocyanatohexane | About 1690 cm⁻¹, | 54 | 0.93 |
| | | | About 2275 cm⁻¹ | | |

As shown in Tables 3 and 4, the batteries according to the examples in which the first compound and the isocyanato compound were added had a remaining capacity ratio higher than that of the batteries according to the comparative examples in which those compounds were not added and had a low value of impedance at 1 kHz. Therefore, it was shown that the nonaqueous electrolyte secondary battery according to the embodiment had little self-discharge and low battery resistance.

In the batteries according to examples and comparative examples in which the isocyanato compound was added, it was shown that the peak was detected at about 1690 cm⁻¹ by FT-IR and the compound having an amino group was present on the negative electrode. In Examples A-5, A-6, B-1, and C in which the isocyanato compound was detected as the component II, it was shown that the peak was detected at about 2275 cm⁻¹ by FT-IR and the compound having an isocyanato group was present on the negative electrode.

In Comparative examples A-2 and B-1 in which only the isocyanato compound was added and the first compound was not added, the remaining capacity ratio was high and the impedance at 1 kHz was also high. This suggested that the battery resistance was reduced by adding the first compound.

From the results of Comparative examples D-1 and D-2, it was shown that when graphite was used for the negative electrode active material, the impedance was significantly increased by adding the isocyanato compound and the remaining capacity was low. It was assumed that the additive was completely reduced on the surface of the negative electrode and the reduction product was excessively accumulated on the surface of the negative electrode, thereby reducing the battery performance.

In Example B-1 in which tris(trimethylsilyl)borate was used as the first compound, the remaining capacity ratio was higher than that of Comparative example A-1 in which no additive was added and the impedance was low. The remaining capacity ratio was higher than that of Comparative example B-1 in which the first compound was not added and that of Comparative example B-2 in which the isocyanato compound was not added, and the impedance was lower than that of Comparative example B-1 and that of Comparative example B-2.

The remaining capacity ratio and impedance in Examples B-2 and B-3 in which the compound having an isocyanato group was added as the isocyanato compound were nearly equal to those of Example A-1. Therefore, it was shown that even if the compound having an isocyanato group was used, a sufficient effect was obtained.

The impedance of Example B-4 in which fluoro trimethylsilane was added as the first compound was lower than that of Comparative example A-2. Thus, it was shown that the impedance was reduced by adding fluoro trimethylsilane as the first compound.

In Examples A-1 to A-4 in which the additive amount of the isocyanato compound was small, the isocyanato compound was not detected as the component II. This showed that when the additive amount of the isocyanato compound was small, the whole isocyanato compound was converted into the amino compound. The remaining capacity ratios in Examples A-5 and A-6 in which the isocyanato compound was detected were higher than those of Examples A-1 to A-4. Therefore, it is considered to be desirable that both the isocyanato compound and the amino compound are present in the battery, from the viewpoint of maintaining the battery performance over a long period of time.

It was shown that a part of the first compound, like tris(trimethylsilyl)phosphate or tris(trimethylsilyl)borate, was converted into fluoro trimethylsilane.

### Examples F-1 and F-2

Nonaqueous electrolyte secondary batteries were produced similarly to Example A-1 except that the isocyanato compound and the amino compound were added as shown in Table 5 during preparation of the nonaqueous electrolyte. The batteries according to Examples F-1 and F-2 were subjected to electrochemical measurement and component detection similarly to the above manner. The results are shown in Table 6.

TABLE 5

| | Negative | | | Additive | | Additive | | Additive |
|---|---|---|---|---|---|---|---|---|
| | electrode | Positive electrode | | amount | Isocyanato | amount | Amino | amount |
| | active material | active material | First compound | (% by mass) | compound | (% by mass) | compound | (% by mass) |
| Example | Li₄Ti₅O₁₂ | LiNi_{0.82}Co_{0.15}Al_{0.03}O₂ | Tris(trimethylsilyl) | 2 | 1,6-Diiso- | 0.5 | 1,6- | 0.5 |
| F-1 | | | phosphate | | cyanatohexane | | Diaminohexane | |
| Example | Li₄Ti₅O₁₂ | LiNi_{0.82}Co_{0.15}Al_{0.03}O₂ | Tris(trimethylsilyl) | 2 | 1,4-Diiso- | 0.5 | 1,4- | 0.5 |
| F-2 | | | phosphate | | cyanatobutane | | Diaminobutane | |

TABLE 6

| | | | | Remaining | |
|---|---|---|---|---|---|
| | Detection | Detection | Peak position | capacity | Impedance |
| | component I | component II | of FT-IR | ratio (%) | at 1 kHz |
| Example | Fluoro trimethylsilane | 1,6-Diisocyanatohexane | About 1690 cm⁻¹, | 60 | 0.92 |
| F-1 | | | About 2275 cm⁻¹ | | |
| Example | Fluoro trimethylsilane | 1,4-Diisocyanatobutane | About 1690 cm⁻¹, | 58 | 0.93 |
| F-2 | | | About 2275 cm⁻¹ | | |

As is apparent from Table 6, in Examples F-1 and F-2 in which the amino compound was added together with the isocyanato compound, the remaining capacity ratio was high and the impedance at 1 kHz was low. Therefore, it was shown that the batteries had little self-discharge and low battery resistance.

### Examples G-1 and G-2

Nonaqueous electrolyte secondary batteries were produced similarly to Example A-1 except that the isocyanato compound was not added and the amino compound was added as shown in Table 7 during preparation of the nonaqueous electrolyte. The batteries according to Examples G-1 and G-2 were subjected to electrochemical measurement and component detection similarly to the above manner. The results are shown in Table 8.

TABLE 7

| | | | | Additive | | Additive |
|---|---|---|---|---|---|---|
| | Negative electrode | Positive electrode | | amount | | amount |
| | active material | active material | First compound | (% by mass) | Amino compound | (% by mass) |
| Example | Li₄Ti₅O₁₂ | LiNi_{0.82}Co_{0.15}Al_{0.03}O₂ | Tris(trimethylsilyl)phosphate | 2 | 1,6-Diaminohexane | 0.5 |
| G-1 | | | | | | |
| Example | Li₄Ti₅O₁₂ | LiNi_{0.82}Co_{0.15}Al_{0.03}O₂ | Tris(trimethylsilyl)phosphate | 2 | 1,4-Diaminobutane | 0.5 |
| G-2 | | | | | | |

TABLE 8

| | | | | Remaining | |
|---|---|---|---|---|---|
| | Detection | Detection | Peak position | capacity | Impedance |
| | component I | component II | of FT-IR | ratio (%) | at 1 kHz |
| Example | Fluoro trimethylsilane | — | About 1690 cm⁻¹ | 54 | 0.94 |
| G-1 | | | | | |
| Example | Fluoro trimethylsilane | — | About 1690 cm⁻¹ | 52 | 0.94 |
| G-2 | | | | | |

As is apparent from Table 8, in the battery according to Examples G-1 and G-2 in which the isocyanato compound was not added and the amino compound was added, the remaining capacity ratio was high and the impedance at 1 kHz was low. Therefore, it is shown that when the amino compound is added in place of the isocyanato compound, a battery having little self-discharge and low battery resistance can also be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A nonaqueous electrolyte battery comprising:
a positive electrode;
a negative electrode comprising a negative electrode active material causing insertion and release of lithium ion in a potential of 1.0 V or higher relative to metallic lithium; and
a nonaqueous electrolyte being liquid at 20° C. under a pressure of 1 atmosphere;
wherein the nonaqueous electrolyte comprises a first compound having a functional group represented by Chemical formula (I), at least one compound selected from a compound having an isocyanato group and a compound having an amino group, a nonaqueous solvent, and an electrolyte: 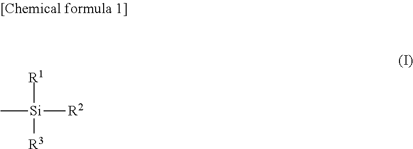
wherein, R¹, R², and R³ each represent any one selected from the group consisting of an alkyl group having 1 to 10 carbon atoms, an alkenyl group having 2 to 10 carbon atoms, and an aryl group having 6 to 10 carbon atoms.

2. The battery according to claim 1, wherein the first compound is selected from tris(trimethylsilyl)phosphate and fluorotrimethylsilane.

3. The battery according to claim 1, wherein the content of the first compound is 0.05% by mass or more based on the total mass of the nonaqueous electrolyte.

4. The battery according to claim 1, wherein the compound having an isocyanato group is at least one selected from compounds represented by Chemical formula (II) and compounds represented by Chemical formula (III).
R—NCO (II)
NCO—R—NCO (III)
wherein R represents a linear hydrocarbon having 1 to 10 carbon atoms.

5. The battery according to claim 4, wherein the compound having an isocyanato group is at least one compound selected from the group consisting of 1,2-diisocyanatoethane, 1,3-diisocyanatopropane, 1,4-diisocyanatobutane, 1,5-diisocyanatopentane, 1,6-diisocyanatohexane, 1,7-diisocyanatoheptane, and 1,8-diisocyanatooctane.

6. The battery according to claim 1, wherein the compound having an amino group is at least one compound selected from compounds represented by Chemical formula (IV) and compounds represented by Chemical formula (V).
R—NH₂ (IV)
NH₂—R—NH₂ (V)
wherein, R represents a linear hydrocarbon having 1 to 10 carbon atoms.

7. The battery according to claim 6, wherein the compound having an amino group is at least one compound selected from the group consisting of 1,2-diaminoethane, 1,3-diaminopropane, 1,4-diaminobutane, 1,5-diaminopentane, 1,6-diaminohexane, 1,7-diaminoheptane, and 1,8-diaminooctane.

8. The battery according to claim 1, wherein the content of compound selected from the compound having an isocyanato group and the compound having an amino group is from 0.05% by mass to 2% by mass based on the total mass of the nonaqueous electrolyte.

9. The battery according to claim 1, wherein the negative electrode active material is a lithium titanium composite oxide.

10. A battery comprising:
a positive electrode,
a negative electrode comprising a negative electrode active material causing insertion and release of lithium ion in a potential of 1.0 V or higher relative to metallic lithium; and
a nonaqueous electrolyte being liquid at ordinary temperature;
wherein the nonaqueous electrolyte comprises a nonaqueous solvent, an electrolyte, and a first compound having a functional group represented by Chemical formula (I), and
the negative electrode has a coating being formed on a surface of the negative electrode and containing at least one compound selected from a compound having an isocyanato group and a compound having an amino group: 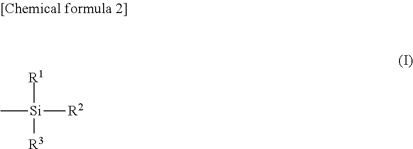
wherein, R¹, R², and R³ each represent any one selected from the group consisting of an alkyl group having 1 to 10 carbon atoms, an alkenyl group having 2 to 10 carbon atoms, and an aryl group having 6 to 10 carbon atoms.
